(19) United States
(12) Patent Application Publication
(10) Pub. No.: US 2025/0378492 A1
(43) Pub. Date: Dec. 11, 2025

(54) AUTOMATED GENERATION AND EXECUTION OF SMART CONTRACTS FOR MULTIPLE ORACLE NETWORKS

(71) Applicant: RAYMOND JAMES FINANCIAL, INC., Saint Petersburg, FL (US)

(72) Inventors: Gregory Charles Akin, Saint Petersburg, FL (US); Tyler Garrett Moore, Saint Petersburg, FL (US); Sean Douglas Crocker, Saint Petersburg, FL (US); Aitor Arkaitz Narvaez, Saint Petersburg, FL (US)

(21) Appl. No.: 18/736,857

(22) Filed: Jun. 7, 2024

(51) Int. Cl. G06Q 40/04; G06Q 20/38

(52) U.S. Cl. CPC G06Q 40/04; G06Q 20/389

(57) ABSTRACT

Systems and methods are disclosed for systems and methods for automated generation and execution of smart contracts for multiple oracle networks. Example methods may include determining, at a first time interval, a first request to process a first brokerage transaction, determining, using the first metadata, a first smart contract template from a set of smart contract templates, generating a first smart contract for the first request using the first smart contract template, and sending the first smart contract to a first blockchain using a first oracle network. Example methods may include sending the first smart contract to a second blockchain using a second oracle network, determining, using a third oracle network, that the first smart contract is executed via the first blockchain, determining, using data published on the first blockchain, that the first request is complete, and generating, at a second time interval, a settlement notification.

### BACKGROUND

In the last 30 years, the brokerage industry has focused on reducing the amount of time required for trade settlement to be completed after a trade is submitted. Currently, the systems used to complete the settlement process are generally configured to perform, at most, a “T+1” settlement, meaning that the settlement is completed a day after the trade is requested. This provides a degree of leeway in the settlement process, as any issues encountered by the system on the day the trade is requested may be resolved after trading has closed on that same day. However, this same leeway would not be afforded if such systems were to be transitioned to performing “T+0” (or same day) settlements, as issues may need to be identified and resolved in real-time. This adds further complexity to the settlement process and conventional systems may not have the capabilities to ensure that all settlements are able to be performed same day. Moreover, current computer and network architecture may not support same day settlement. As a result, automated generation and execution of smart contracts for multiple oracle networks may be desired.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 shows a schematic illustration of an example use case for automated generation and execution of smart contracts for multiple oracle networks in accordance with one or more example embodiments of the disclosure.

FIG. 2 shows a schematic illustration of example system architecture for automated validation and deployment of machine learning models in accordance with one or more example embodiments of the disclosure.

FIG. 3 shows an example flow diagram for automated generation and execution of smart contracts for multiple oracle networks in accordance with one or more example embodiments of the disclosure.

FIGS. 4A-4C show another example flow diagram for automated generation and execution of smart contracts for multiple oracle networks in accordance with one or more example embodiments of the disclosure.

FIGS. 5A-5F show example user interfaces for automated generation and execution of smart contracts for multiple oracle networks in accordance with one or more example embodiments of the disclosure.

FIG. 6 shows an example system for automated generation and execution of smart contracts for multiple oracle networks in accordance with one or more example embodiments of the disclosure.

FIG. 7 shows a schematic block diagram of an illustrative device in accordance with one or more example embodiments of the disclosure.

### DETAILED DESCRIPTION

### Overview

This disclosure relates to, among other things, devices, systems, methods, computer-readable media, techniques, and methodologies for automated generation and execution of smart contracts for multiple oracle networks. That is, an improved system is provided that allows for “T+0” or same day settlements to be performed, which may otherwise not be possible with conventional settlement systems. To accomplish this, the system is configured to perform real-time monitoring, management, and mitigation of all tasks associated with the settlement process. The system is also configured to reduce the amount of processing latency associated with performing the myriad of complex tasks that are necessary for settlement to be completed. Embodiments include computer and network architecture that support same day settlement, unlike currently available technology.

Particularly, the system involves the use of one or more blockchains that are used to store any smart contracts that are generated in association with any trade requests (the term “transactions requests” may also be used interchangeably herein) to be settled. A smart contract is a program that is hosted and executed on a blockchain, for example. A smart contract includes code that specifies one or more conditions that, when met, trigger one or more corresponding actions to be performed. For example, a smart contract may be created for a trade request and the smart contract may include conditions associated with all of the requirements for settlement of the trade request to be completed. The resulting actions, when the conditions are satisfied, may include actions associated with completing the trade (for example, transferring funds from a brokerage account, transferring ownership of assets to the user's brokerage account, etc.). Storing the trade requests as smart contracts on blockchains allows for the automation of the settlement process while also providing a secure mechanism for storing the data that still allows a user managing the settlement process to view information about block on the blockchain and the status of the tasks associated with the settlement process.

Blockchains are decentralized elements that may not typically have access to external information. However, access to external information may be necessary for operation of the smart contracts stored on the blockchains. For example, the smart contract may require information about the amount of available funds in a brokerage account, the current price of a particular stock, and/or any other types of information required to settle a trade that may only be available in data sources that are external to the blockchain. Accordingly, to facilitate data communications to and from the blockchains, one or more oracle networks may be used.

Multiple different types of such oracle networks may be employed. One type of oracle network is an inbound or input oracle network. This type of oracle network obtains data from data sources that are external to a blockchain and provides the information to the blockchain. For example, an inbound oracle network may provide external financial market data, information about a user's borrowing capacity, and/or any other type of relevant information to a blockchain for use by the smart contract. Another type of oracle network is an outbound or output oracle network. The outbound oracle networks allow the smart contracts stored on the blockchain to send commands to external systems that cause the systems to perform certain actions. For example, transfer funds from a brokerage account, etc. Another type of oracle network is a cross-chain oracle network. This type of oracle network allows for communications to be performed between different blockchains. Any other type of oracle network may also be used.

In embodiments, the system specifically involves the use of multiple blockchains that may store copies of the same smart contracts that are generated for a trade request. In this manner, parallel processing may be employed to reduce the amount of processing time required to perform all of the tasks required for settlement of the trade request. Otherwise, such as in conventional systems, it may not be possible to perform the processing required to complete all of the tasks for a “T+0” settlement. Performing parallel processing also allows for any issues that arise with any of the settlement tasks to be more quickly identified in real-time and resolved. If only a single blockchain were used and tasks were processed serially, then one specific tasks experiences an issue may bottleneck the remaining tasks from being performed, adding significant latency to the settlement process. With parallel processing, other tasks may still be processed and completed even if one particular tasks experiences an issue that requires resolution.

Likewise, the system may also include multiple of the same type of oracle network for efficient data transfer to and from the plurality of blockchains. For example, one inbound oracle network and one outbound oracle network may be associated with each of the individual blockchains. However, this is not intended to be limiting, and any other number of each of the different types of oracle networks may also be provided.

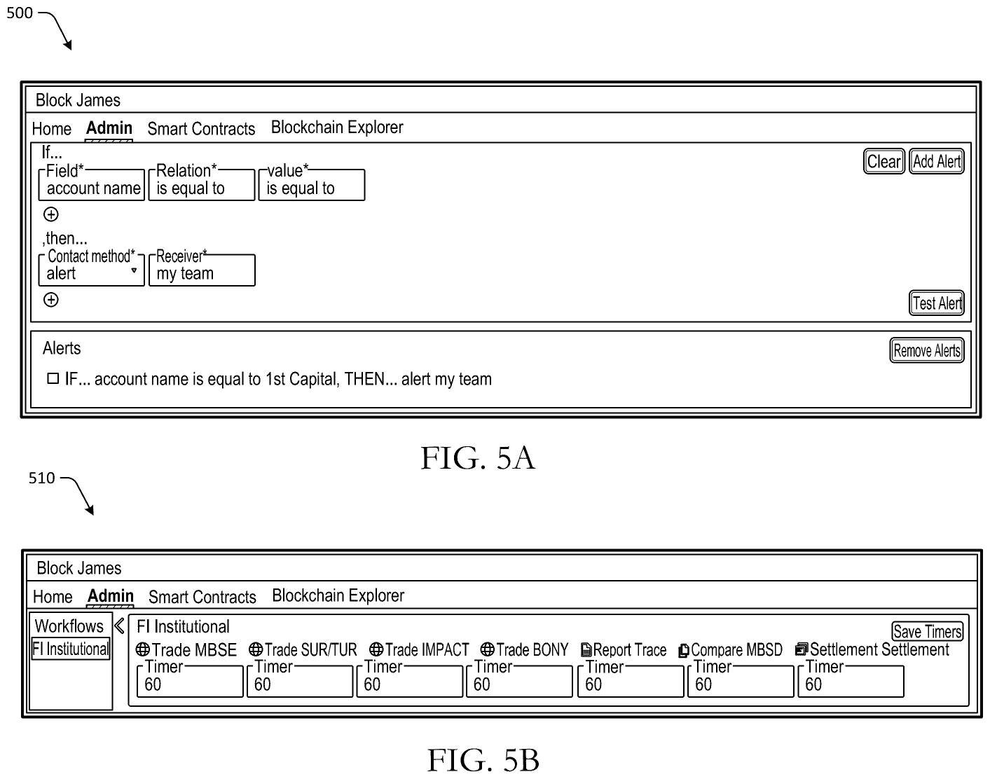

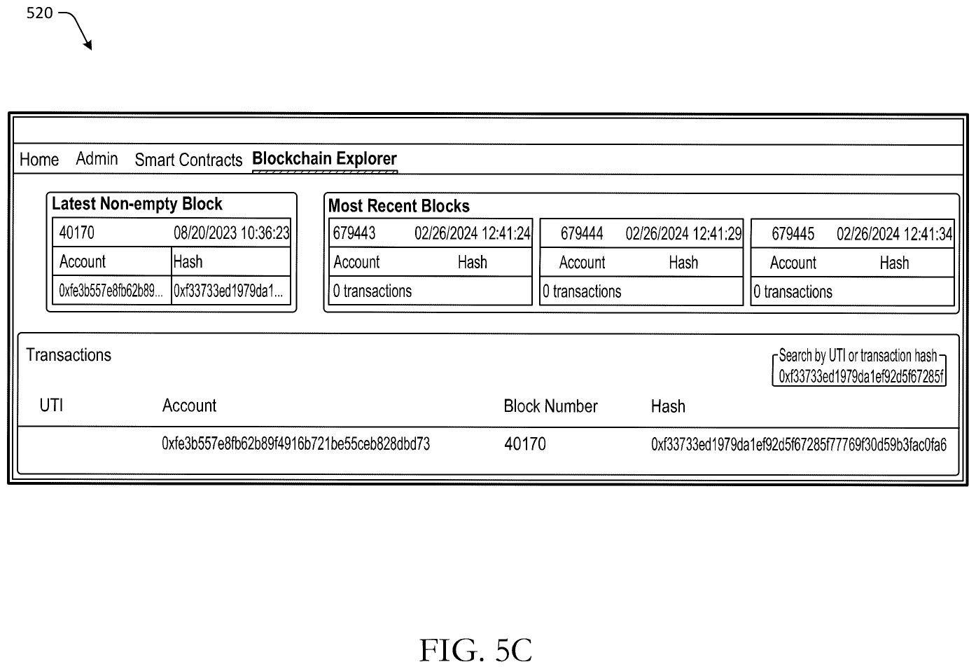

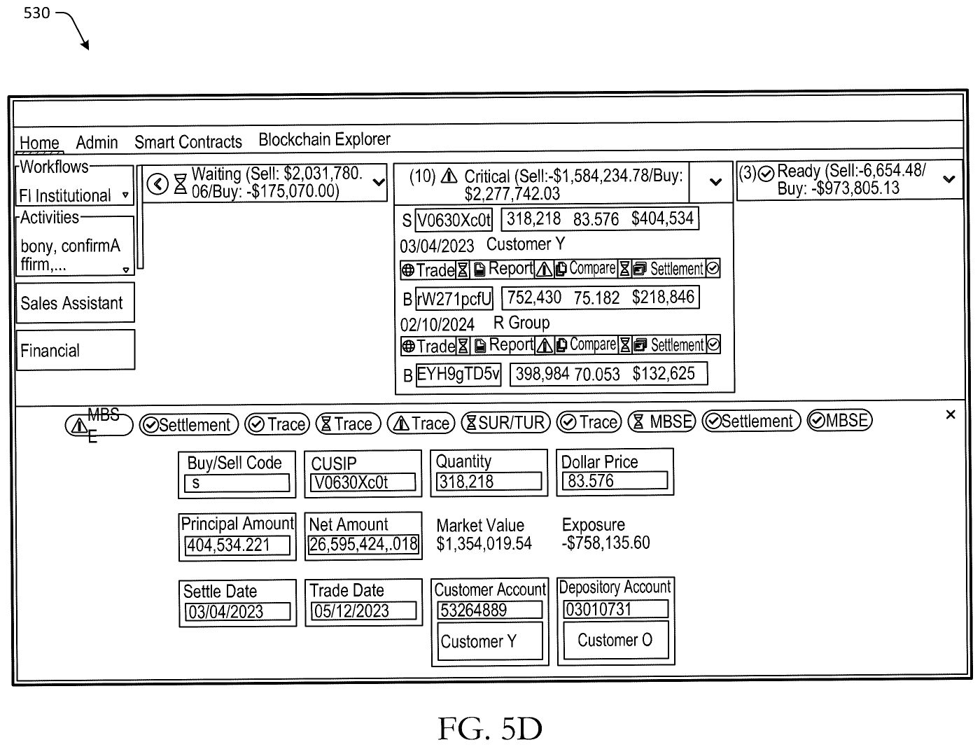

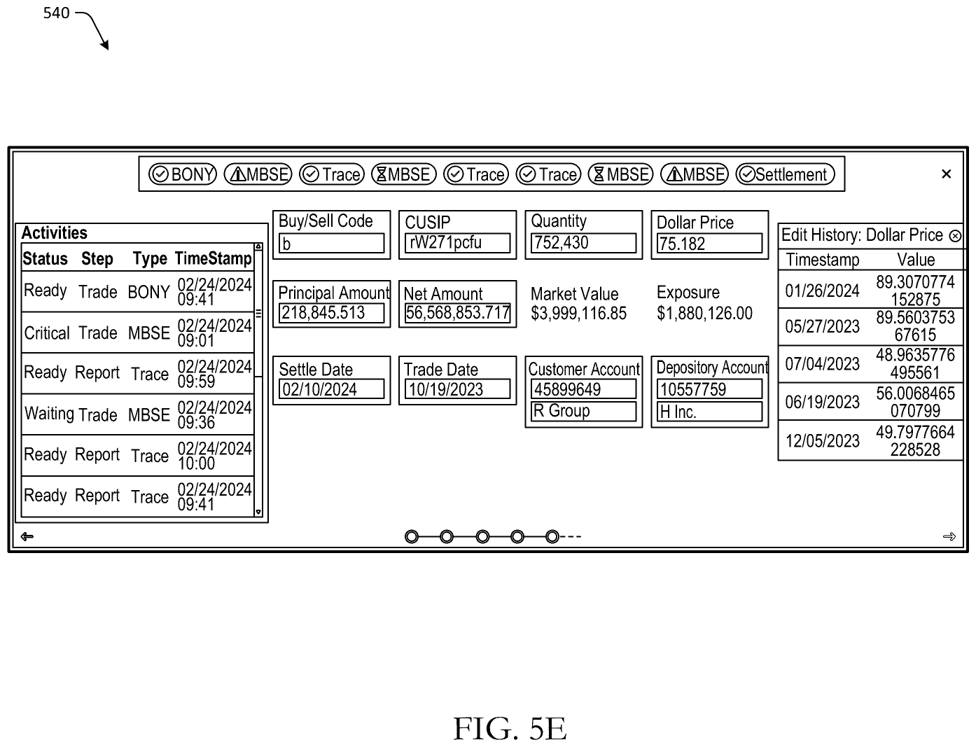

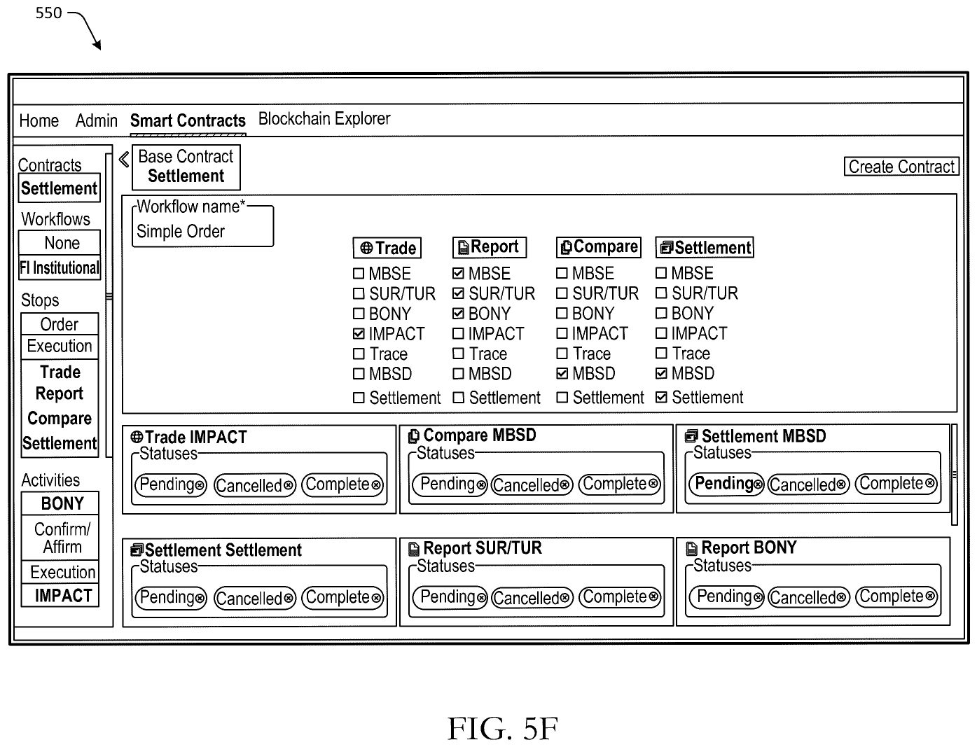

The system also advantageously includes a frontend application by which users may create smart contracts, view information about the tasks being performed during the settlement process, view alerts generated based on issues that arise during the settlement process, and resolve such issues (or view information about how such issues were automatically resolved by the system). Examples of different user interfaces that may be presented to a user via the frontend application are shown in FIGS. 5A-5F. This type of frontend application that allows for generation of smart contracts and real-time monitoring and issue resolution is non-existent in conventional settlement systems. Therefore, managing settlement and resolving complications with settlement is inherently more complex in conventional systems and often requires the operator to have a threshold level of expertise.

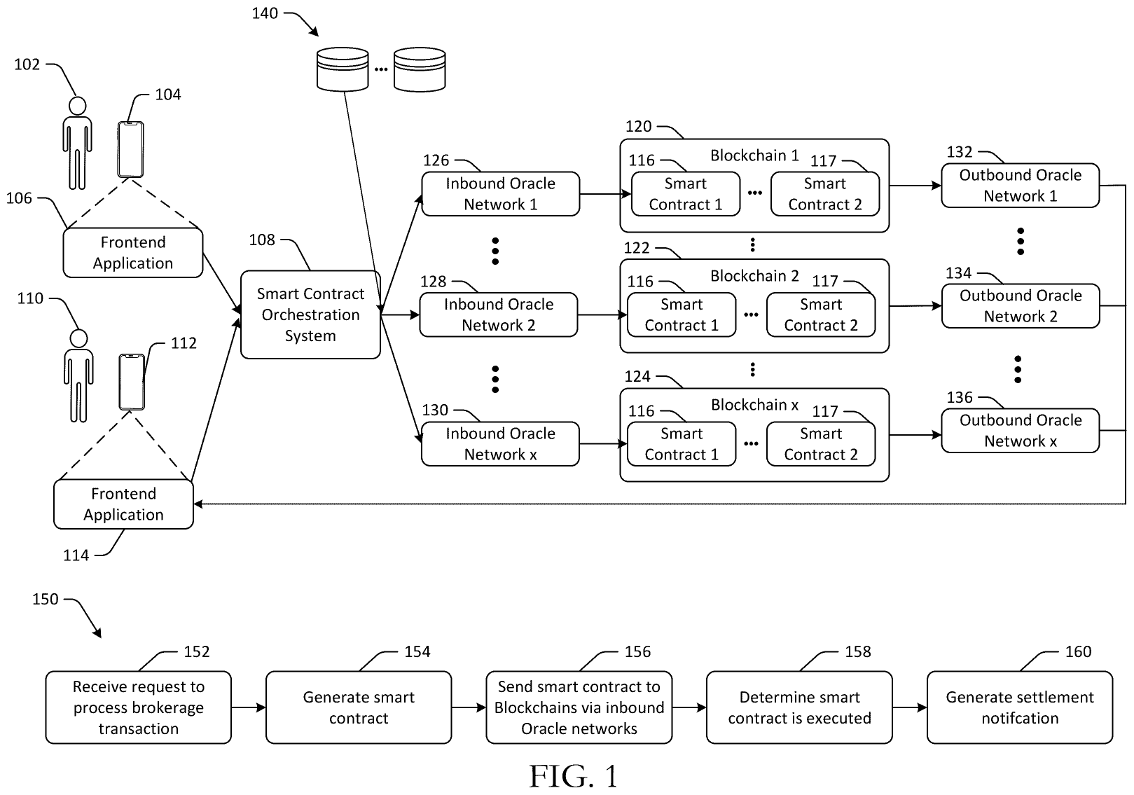

Turning to the figures, FIG. 1 shows a schematic illustration of an example use case 100 for automated generation and execution of smart contracts for multiple oracle networks. The use case 100 begins with a user 102 executing a trade via a frontend application 106 provided on a user device 104. For example, the user 102 may be a consumer or end user that is requesting a trade via a brokerage account of the user 102. The user device 104 is illustrated as a smartphone in the figure, however, any other type of user device may be used (for example, a laptop or desktop computer, tablet, etc.). Information about the trade request (for example, the type of trade, the specific stock, the amount desired to be traded, the brokerage account from which the funds should be obtained, etc.) may be provided as metadata to a smart contract orchestration system 108. Using this information, the smart contract orchestration system 108 may automatically generate a first smart contract 116 for use in settlement of the trade request.

In some instances, the smart contract may also be created and/or modified by another user 110 via another frontend application 114 provided on another user device 112 (similar to the device 104, the device 112 may also be any type of device as well). Whereas the user 102 is the user that is requesting the trade, the user 110 may be responsible for facilitating settlement of the trade requested by the user 102 when manual intervention is desired. For example, the frontend application 114 may provide the user 110 access to information about the settlement process associated with the trade, including real-time information about the status of various aspects of the settlement, any alerts that have been generated indicating issues with any aspects of the settlement, etc. The frontend application 114 may also allow the user 110 to manually generate the smart contract associated with the trade (however, this may also be automatically generated by the system). For example, the frontend application 114 may present any of the user interfaces illustrates in FIGS. 5A-5F. In certain embodiments, the frontend application 114 may not be necessary at all and the entire process may be automated by the system. However, the frontend application 114 may still be provided even in embodiments in which the process is fully automated to provide real-time status information to the user 110 monitoring the settlement (even if the user does not manually intervene in the process).

In embodiments, the smart contracts may be implemented as no-code smart contracts. A no-code smart contract is a smart contract that may be generated without a user having to manually write the code associated with the smart contract. For example, in instances in which the smart contract is created by the user 110 rather than being automatically generated by the system, the user 110 may generate the no-code smart contract via the frontend application 114. The frontend application 114 may provide the capability for the user 114 to select certain conditions and actions that may be associated with the settlement process, provide an indication when all of the condition and actions associated with the smart contract have been selected, and then indicate through the frontend application 114 that the smart contract should be generated. The system may then generate the code for the smart contract based on the selections performed by the user 110 without the user 110 being required to write the lines of the code to generate the smart contract. An example of a user interface of the frontend application 114 that allows the user 110 to generate these no-code smart contracts is shown in at least FIGS. 5A-5F. The use of such no-code smart contracts allows for smart contract generation to be performed by users who may not otherwise have the expertise to code a standard smart contract using a programming language.

Additionally, the generation of smart contracts may even further enhanced through the use of pre-determined and stored smart contract templates. The smart contract templates may be pre-written code that may be customized for different use cases. Rather than the system generating all of the code for the smart contract at the time of creation, the system may identify one of the templates that is most relevant to the particular type of transaction that is requested, select that template, and customize the template to fit the particular transaction. For example, one smart contract template may be stored for a buy order for a stock. When a transaction request is received for a buy order for a specific stock, the system may identify this template as being the most relevant and may modify the code of the template to fit the details of the transaction. For example, the system may add the identifying information for the stock, the number of shares, etc. In scenarios where the smart contract is manually created, a listing of templates may also be provided to the user 110 and the user 110 may select the template that is most relevant (or the system may automatically select the most appropriate template and provide the template to the user 110). This serves to further reduce the amount of processing time in the settlement process.

In the use case 100, a first smart contract 116 is shown as being created for a trade request performed by the user 102. Once the first smart contract 116 is generated, the first smart contract 116 may be provided to a first blockchain 120. As aforementioned, the blockchain 120 may normally be decentralized and not have access to external data sources to receive the first smart contract 116. Accordingly, a first inbound oracle network 126 that may be used to provide the first smart contract 116 to the first blockchain 120. Additionally, to reduce the latency associated with the processing of tasks required for settlement of the trade associated with the first smart contract 116, copies of the first smart contract 116 may be provided to a plurality of blockchains to allow for parallel processing of the required tasks to be performed. For example, the use case 100 shows copies of the smart contract 116 being provided to a second blockchain 112 and a third blockchain 124, however, any other blockchains may also be used. Accordingly, multiple inbound oracle networks (for example, second inbound oracle network 128, third inbound oracle network 130, etc.) may also be provided to facilitate providing the copies of the first smart contract 116 to the different blockchains. FIG. 1 also shows a second smart contract 117 that is stored on the first blockchain 120, second blockchain 122, and third blockchain 124, indicating that any number of smart contracts may be generated and stored on the blockchains simultaneously.

The inbound oracle networks may also be used to obtain information from external data sources that may be used to monitoring for conditions that trigger the first smart contract 116. For example, data may be obtained by the one or more blockchains from one or more databases 140 via the one or more inbound oracle networks. As aforementioned, this information may include any information that may be relevant to the settlement of the trade request associated with the first smart contract 116.

Additionally, information stored on the one or more blockchains (for example, information about any of the smart contracts or any other types of relevant information) may be provided externally to the one or more blockchains via one or more outbound oracle networks (for example, outbound oracle network 132, outbound oracle network 134, outbound oracle network 136, and/or any other number of outbound oracle networks.

Providing this data externally to the one or more blockchains may serve a number of purposes. As a first example, the outbound oracle network 132 may obtain real-time status information about the operation of the smart contract 116 from the blockchain 120 and may present such information to the user 110 via the frontend application 114. This allows the user 110 to view information about the status of the settlement tasks associated with the first smart contract 116. Conventionally, this information would not otherwise be available for viewing as blockchains are decentralized and do not have access to external entities and also applications for viewing such information in real-time are non-existent in conventional settlement systems. As a second example, the outbound oracle network 132 may also provide commands for actions to be performed based on conditions being satisfied with respect to the smart contract 116. For example, the smart contract 116 may trigger a command to withdraw funds from a brokerage account and complete a trade. Thus, the command may be transmitted to an external system that may facilitate these actions using the outbound oracle network 132.

In embodiments, the one or more blockchains may specifically be private blockchains. In this manner, the information stored in the blockchains may generally be inaccessible to external users and/or systems other than those external users and/or systems that have authorization to access the information. For example, other users performing trades via frontend application 106 may not have access to the blocks on the blockchains, however, the user 110 may have access to some or all of this information via the frontend application 114 to facilitate settlement of the trade request.

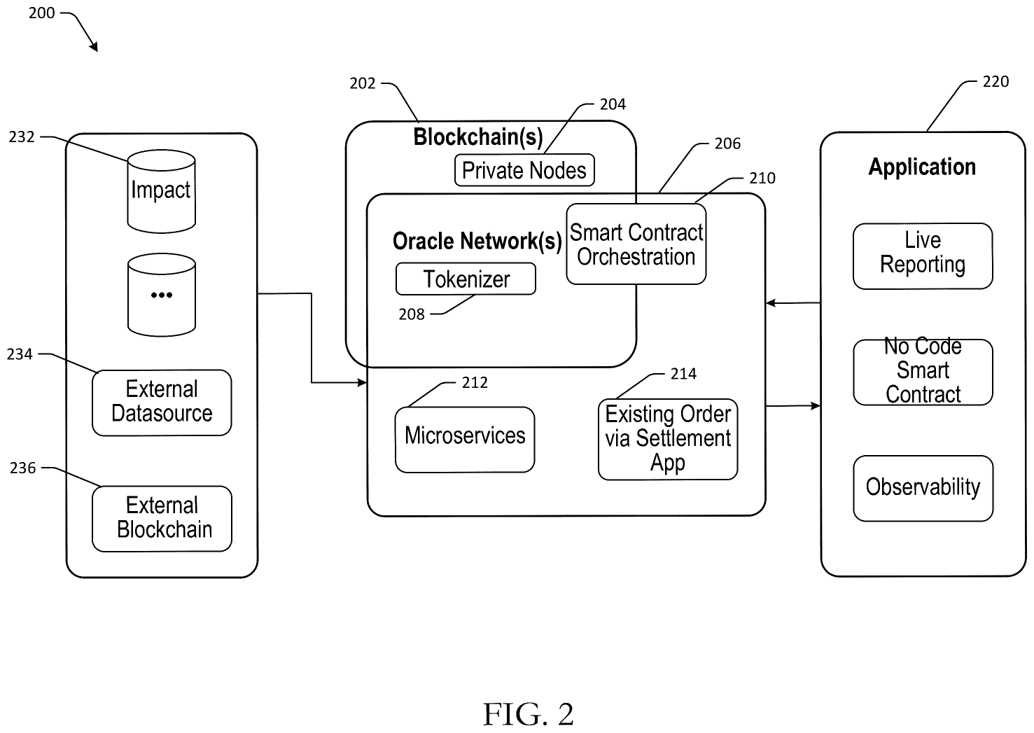

To automatically generate and execute smart contracts for multiple oracle networks, an example process flow 150 is presented and may be performed, for example, by a device (as a non-limiting example, computing device 610, which may be a server). The device may include at least one memory that stores computer-executable instructions and at least one processor configured to access the at least one memory and execute the computer-executable instructions to perform various actions or operations, such as one or more of the operations in the process flow 150 of FIG. 1. For example, the device may include the smart contract orchestration system 108 and/or some or all of the elements of the system architecture 200 of FIG. 2.

At block 152, the device may receive a request to process a brokerage transaction (also generally referred to as a “trade request” or “transaction request” herein). The brokerage transaction, for example, may be initiated by the user 102 via the frontend application 106, which, as aforementioned, may be a brokerage application that allows a user to submit buy and sell orders, among various other types of transaction requests that may be performed with a brokerage account.

At block 154, the device may generate a smart contract. In some instances, the smart contract may automatically be generated based on the specific transaction request received from the frontend application 106. For example, the transaction request may include metadata providing details about the transaction and the metadata may be used by the device to determine the specific conditions and actions to provide to the smart contract. However, in some cases, a no-code smart contract may also be manually generated by a user (such as user 110) via the frontend application 114 as well. In yet further cases, the device may initially generate the smart contract and the user 110 may verify that the smart contract was correctly generated (this verification may also be performed automatically as well).

At block 156, the device may send the smart contract to a plurality of blockchains using inbound oracle networks. For example, copies of a smart contract may be stored on a plurality of different blockchains (e.g., blockchain 120, blockchain 122, blockchain 124, etc.) such that parallel processing the tasks associated with settlement of the transaction request using the smart contract may be performed. The copies of the smart contract may be provided to the blockchains via various inbound oracle networks (e.g., inbound oracle network 126, inbound oracle network 128, inbound oracle network 130, etc.).

At block 158, the device may determine that the smart contract has been executed. That is, a given smart contract may include a number of conditions tied to various tasks for the settlement process to be completed. Once all of the conditions required for settlement have been satisfied, the smart contract may automatically trigger one or more post-settlement actions. For example, the smart contract may cause a notification of settlement (at block 160) to be provided to the frontend application 114. The settlement notification may also be provided to any other device. The smart contract may also automatically trigger funds to be transferred form the brokerage account of the user 102, and/or any other actions required to complete settlement of the brokerage transaction.

Example embodiments of the disclosure provide a number of technical features or technical effects. For example, in accordance with example embodiments of the disclosure, certain embodiments of the disclosure may provide for reductions in latency associated with settlement completion systems, which is imperative for T+0 settlement times and otherwise not possible using conventional settlement systems. The embodiments of the disclosure also provide for systems that allow for real-time monitoring and issue resolution for the settlement process. As a result of improved functionality, latency in complex settlement processing may be improved, thereby improving functionality of computer systems. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Process and Use Cases

FIG. 2 is a schematic illustration of an example system architecture 200 in accordance with one or more example embodiments of the disclosure. The system architecture 200 shows exemplary elements of the system as descried herein and may not necessarily be a comprehensive illustration of every element of the system.

The system 200 includes one or more blockchain(s) 202 (which may be the same as blockchain 122, blockchain 124, blockchain 126, and/or any other number of blockchains). The blockchains 202 may include private nodes 204, which may be blocks including any smart contracts that are stored on the blockchain(s) 202. The blockchain(s) 202 may be private blockchain(s) such that the private nodes 204 forming the blockchain(s) 202 are not accessible to the general public, but may be made accessible on a permissions basis.

Given that the blockchain(s) 202 are decentralized, the blockchain(s) 202 may be provided the capability to send and/or receive data via one or more oracle network(s) 206 (which may include any of the inbound oracle networks or outbound oracle networks described with respect to FIG. 1, as well as any other oracle networks described herein or otherwise). A tokenizer 208 may be provided to convert any information into a token representation that may be stored on the blockchain(s) 202.

The oracle network(s) 206 may connect the blockchain(s) 202 to a smart contract orchestration system 210 (which may be the same as smart contract orchestration system 108 of FIG. 1). The microservice(s) 212 may include any service in the oracle network that is not related to tokenizer 208 and 210 smart contract orchestration 210 and is not an existing application. These services may act as interfaces for external data sources and external blockchains and internal databases that may not currently have API access. For example, the microservice(s) 212 may include a no-code smart contract builder that may provide an interface that allows a user to generate a no-code smart contract. The existing order via settlement application(s) 214 may represent existing internal solutions that support and order through settlement flow. Accordingly, the existing order via settlement application(s) 214 may include anything from databases to servers to internal web applications. They are included in the oracle network(s) 206 because access to the API may not be mediated through the application 220.

As one example, the oracle network(s) 206 may perform communications with one or more external data sources. For example, an impact database 232 (or other type of database), an external data source 234, an external blockchain 236, and/or any other external source of information that may be used in association with settlement of a transaction request.

As another example, the oracle network(s) 206 may perform communications with a frontend application 220 (which may be the same as frontend application 114, settlement management application 604, etc.). The frontend application 220 may include any capabilities described herein, such as real-time reporting on the status of various tasks associated with the settlement of any transaction requests, generation of no-code smart contracts, alert generation, etc.

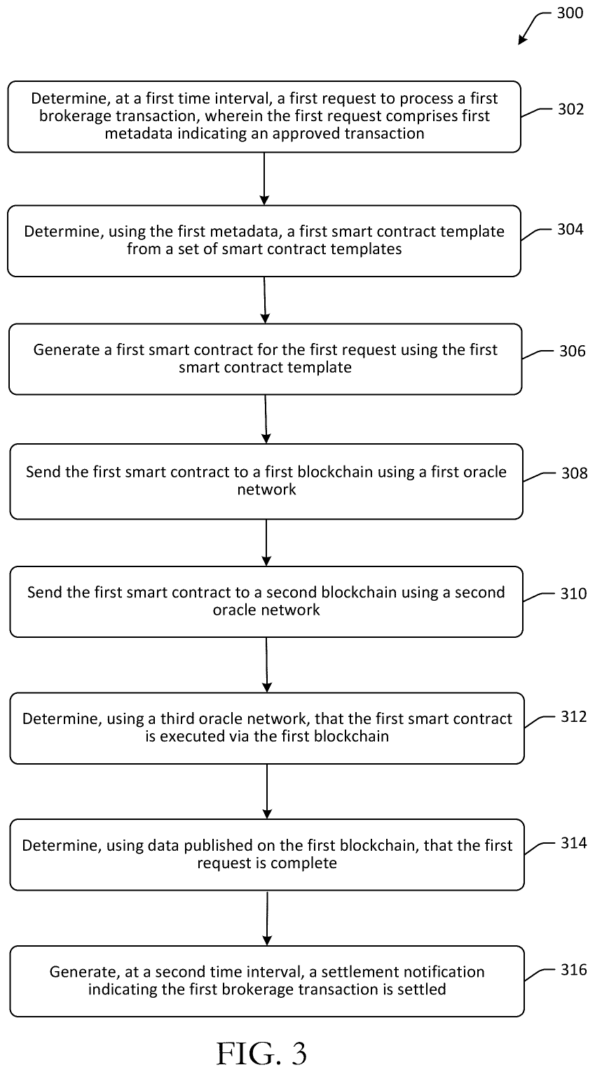

FIG. 3 depicts an example flow diagram 300 for automated generation and execution of smart contracts for multiple oracle networks in accordance with one or more example embodiments of the disclosure. While example embodiments of the disclosure may be described in the context of production networks, it should be appreciated that the disclosure is more broadly applicable to any type of network. Some or all of the blocks of the process flows in this disclosure may be performed in a distributed manner across any number of devices. Some of the operations of the process flow 300 may be optional and may be performed in a different order.

At block 302 of the process flow 300, computer-executable instructions stored on a memory of a device, such as a server, may be executed to determine at a first time interval, a first request to process a first brokerage transaction, wherein the first request comprises first metadata indicating an approved transaction.

At block 304 of the process flow 300, computer-executable instructions stored on a memory of a device, such as a server, may be executed to determine, using the first metadata, a first smart contract template from a set of smart contract templates.

At block 306 of the process flow 300, computer-executable instructions stored on a memory of a device, such as a server, may be executed to generate a first smart contract for the first request using the first smart contract template. Data associated with the first smart contract may include, for example, time data, execution status data, account identifier data, and transaction amount data. The smart contract may also be devoid of institutional data. The smart contract may include conditions relating to tasks for completion of settlement of the first brokerage transaction. The smart-contact may be a no-code smart contract that is manually generated by a user or may be automatically generated based on the first metadata associated with the first brokerage transaction (as well as any other information that is relevant to the first brokerage transaction and settlement of the first brokerage transaction).

At block 308 of the process flow 300, computer-executable instructions stored on a memory of a device, such as a server, may be executed to send the first smart contract to a first blockchain using a first oracle network. At block 310 of the process flow 300, computer-executable instructions stored on a memory of a device, such as a server, may be executed to send the first smart contract to a second blockchain using a second oracle network. For example, the first oracle network and the second oracle network may be inbound oracle networks used to provide the smart contracts to the blockchains. The first smart contract may be provided to the first blockchain and the second blockchain such that parallel processing of settlement tasks may be performed to reduce the latency associated with task completion (to allow for T+0 settlement to be performed).

At block 312 of the process flow 300, computer-executable instructions stored on a memory of a device, such as a server, may be executed to determine, using a third oracle network, that the first smart contract is executed via the first blockchain. For example, the third oracle network may be an outbound oracle network that may provide an indication that the first smart contract is executed to an external system. Although reference is made to one outbound oracle network, any other number of outbound oracle networks may also be used. At block 314 of the process flow 300, computer-executable instructions stored on a memory of a device, such as a server, may be executed to determine, using data published on the first blockchain, that the first request is complete. At block 316 of the process flow 300, computer-executable instructions stored on a memory of a device, such as a server, may be executed to generate, at a second time interval, a settlement notification indicating the first brokerage transaction is settled. The operations associated with blocks 314 and 316 may also be performed using the outbound oracle networks. To facilitate a T+0 settlement, the elapsed time between the first time interval and the second time interval may be equal to or less than 6.5 hours. However, this is not intended to be limiting and any other time threshold may be used depending on the time of day at which the brokerage transaction was initiated.

In embodiments, the device may also determine, using a first datastore that is decoupled from the first oracle network, the second oracle network, and the third oracle network, an account identifier. That is, given that the blockchains are decentralized, the oracle networks may be used to facilitate data communications to and from the blockchains. The device may also determine that the first brokerage transaction can be executed using the account identifier, send a settlement approval notification to the first oracle network, determine, via the first oracle network, that the first smart contract is executed, and determine that the first brokerage transaction is settled. The device may also generate a status update associated with the first brokerage transaction. For example, the status information about the first brokerage transaction may be visible in real-time via a frontend application, such as frontend application 114, settlement management application 606, etc.

In some instances, one or more of the tasks associated with settlement of the first brokerage transaction may experience issues that may temporarily prevent settlement from completing. Accordingly, the device may determine, via the first oracle network, that the first smart contract is not executed. The device may also generate an alert notification indicating the first smart contract is not executed. The device may also determine that the first smart contract is not executed due to a manual operator action, generate a message indicating manual operator action is required, determine that the manual operator action is complete, and determine that the first smart contract is executed. As described in additional detail with respect to the user interfaces depicted in FIGS. 5A-5F, the frontend application may provide real-time status information about each of the tasks being performed as part of the settlement process. Additionally, the frontend application may allow users to establish alerts that may trigger based on various conditions. For example, timers for each of the tasks may be established such that if a task is not completed within the allotted time, an alert is provided via the frontend application such that the issue may be resolved in real-time. These alerts may also be provided to a device or system such that the issues may be automatically resolved without requiring manual user intervention.

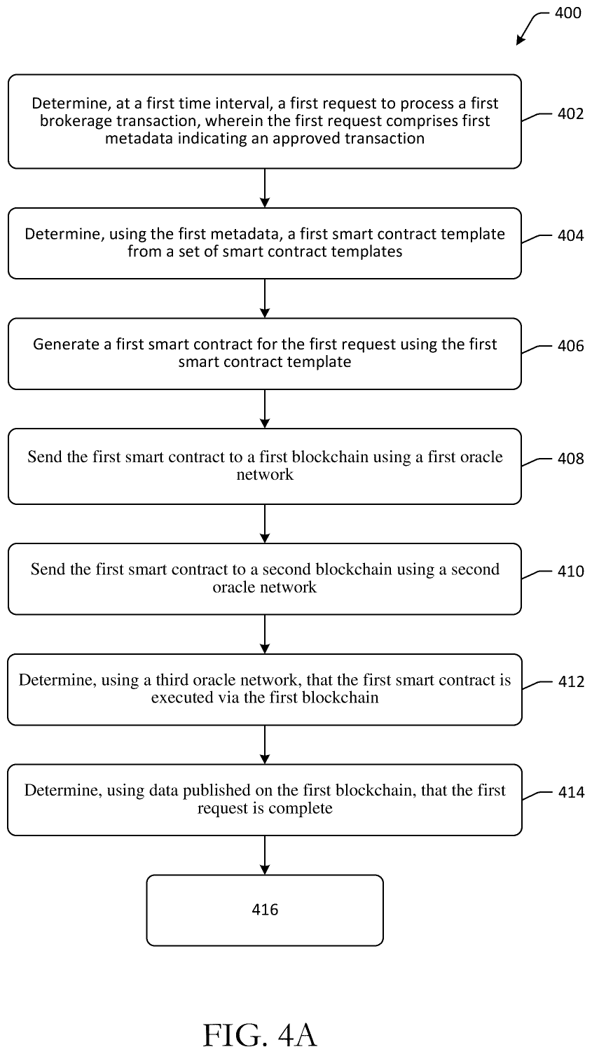

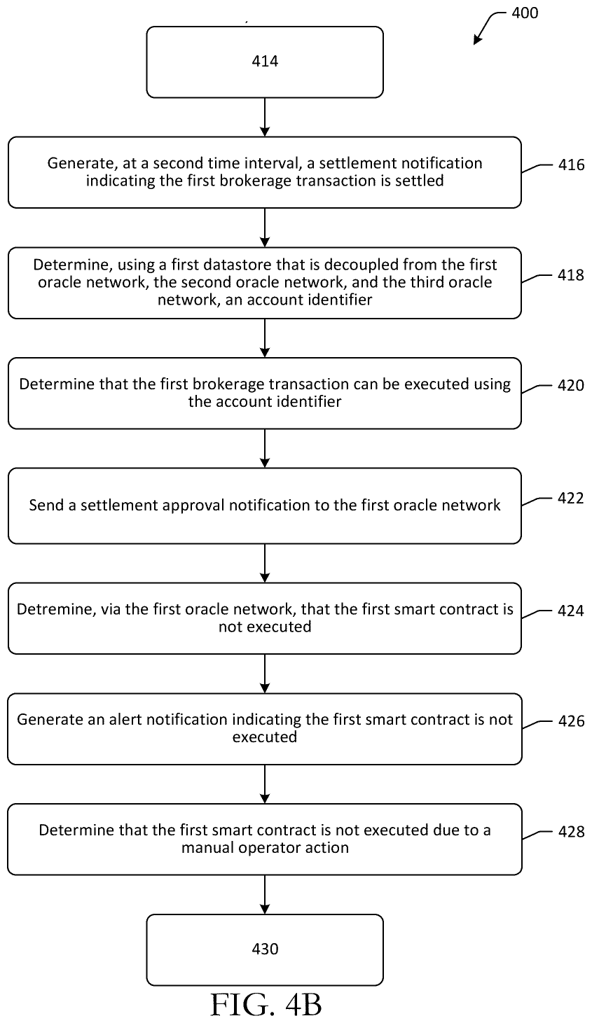

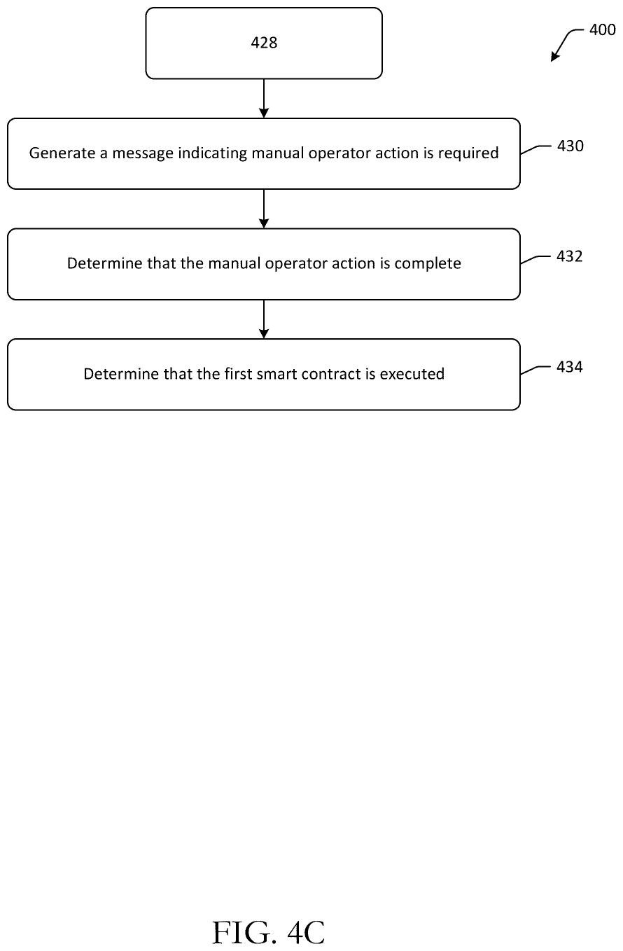

FIGS. 4A-4C depict illustrations of another flow diagram 400 for automated generation and execution of smart contracts for multiple oracle networks in accordance with one or more example embodiments of the disclosure. While example embodiments of the disclosure may be described in the context of production network environments, it should be appreciated that the disclosure is more broadly applicable to any type of network environment. Some or all of the blocks of the process flows in this disclosure may be performed in a distributed manner across any number of devices. Some of the data flow or operations may be optional and may be performed in a different order.

At block 402 of the process flow 400, computer-executable instructions stored on a memory of a device, such as a server, may be executed to determine, at a first time interval, a first request to process a first brokerage transaction, wherein the first request comprises first metadata indicating an approved transaction. At block 404 of the process flow 400, computer-executable instructions stored on a memory of a device, such as a server, may be executed to determine, using the first metadata, a first smart contract template from a set of smart contract templates. At block 406 of the process flow 400, computer-executable instructions stored on a memory of a device, such as a server, may be executed to generate a first smart contract for the first request using the first smart contract template.

At block 408 of the process flow 400, computer-executable instructions stored on a memory of a device, such as a server, may be executed to send the first smart contract to a first blockchain using a first oracle network. At block 410 of the process flow 400, computer-executable instructions stored on a memory of a device, such as a server, may be executed to send the first smart contract to a second blockchain using a second oracle network.

At block 412 of the process flow 400, computer-executable instructions stored on a memory of a device, such as a server, may be executed to determine, using a third oracle network, that the first smart contract is executed via the first blockchain. At block 414 of the process flow 400, computer-executable instructions stored on a memory of a device, such as a server, may be executed to determine, using data published on the first blockchain, that the first request is complete. At block 416 of the process flow 400, computer-executable instructions stored on a memory of a device, such as a server, may be executed to generate, at a second time interval, a settlement notification indicating the first brokerage transaction is settled.

At block 418 of the process flow 400, computer-executable instructions stored on a memory of a device, such as a server, may be executed to determine, using a first datastore that is decoupled from the first oracle network, the second oracle network, and the third oracle network, an account identifier. At block 420 of the process flow 400, computer-executable instructions stored on a memory of a device, such as a server, may be executed to determine that the first brokerage transaction can be executed using the account identifier. At block 422 of the process flow 400, computer-executable instructions stored on a memory of a device, such as a server, may be executed to send a settlement approval notification to the first oracle network.

At block 424 of the process flow 400, computer-executable instructions stored on a memory of a device, such as a server, may be executed to determine, via the first oracle network, that the first smart contract is not executed. At block 426 of the process flow 400, computer-executable instructions stored on a memory of a device, such as a server, may be executed to generate an alert notification indicating the first smart contract is not executed. At block 428 of the process flow 400, computer-executable instructions stored on a memory of a device, such as a server, may be executed to determine that the first smart contract is not executed due to a manual operator action. At block 430 of the process flow 400, computer-executable instructions stored on a memory of a device, such as a server, may be executed to generate a message indicating manual operator action is required.

At block 432 of the process flow 400, computer-executable instructions stored on a memory of a device, such as a server, may be executed to determine that the manual operator action is complete. At block 434 of the process flow 400, computer-executable instructions stored on a memory of a device, such as a server, may be executed to determine that the first smart contract is executed.

One or more operations of the methods, process flows, or use cases of FIGS. 1-4 may have been described above as being performed by a user device, or more specifically, by one or more program module(s), applications, or the like executing on a device. It should be appreciated, however, that any of the operations of the methods, process flows, or use cases of FIGS. 1-4 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-4 may be described in the context of the illustrative devices, it should be appreciated that such operations may be implemented in connection with numerous other device configurations.

The operations described and depicted in the illustrative methods, process flows, and use cases of FIGS. 1-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-4 may be performed.

FIGS. 5A-5F depict example user interfaces 500, 510, 520, 530, 540, and 550 for automated generation and execution of smart contracts for multiple oracle networks in accordance with one or more example embodiments of the disclosure.

Beginning with FIGS. 5A-5B, user interfaces 500 and 510 are examples of at least portions of user interfaces by which a user (such as user 110 of FIG. 1, for example) may establish alerts that may be used to track certain conditions associated with one or more smart contracts. For example, as shown in FIG. 5A, the user interface 500 includes fields through which a user may input various “if” and “then” conditions. The example shown in the figure includes “if” conditions that an account name is equal to a specific bank and a “then” condition of an alert being generated if the “if” conditions are determined to be met. This is merely only non-limiting example of a type of alert that may be set and any other types of alerts may also be set as well.

In some cases, a pre-determined list of “if” and “then” values may be established and the user may select from the pre-determined list via a drop down list in each of the fields. However, in some cases, the user may also manually enter custom values into the fields as well. For example, while the “value” field shows a specific bank, the user may also replace this specific bank with any other entity name (or any other value in general).

Similarly, FIG. 5B shows another user interface 510 by which a user may establish different types of alerts. Particularly, the user interface 510 shows various tasks that may be associated with the settlement of a transaction request. Underneath each of the tasks are fields in which a user may input numerical values indicative of timers associated with each of the tasks. Given that the “T+0” settlement requires the processing to be performed in a time-efficient manner, it may be critical for any issues that arise with any of the settlement tasks to be identified in real-time. The timers may be established such that if a particular task is not completed in the designated period of time, then an alert is produced to indicate that the task has not yet been completed. Although the example in the figure shows all of the timers being the same value, distinct timers may also be set for each of the different tasks.

FIG. 5C illustrates another user interface 520 by which a user may view information about any of the blockchains storing the smart contracts as descried herein. For example, the user interface 520 may present information about the most recent blocks added to the blockchain as well as any other information about the blockchain.

FIGS. 5D-5E illustrates further user interfaces 530 and 540 by which a user may view real-time information about the status of tasks being performed in association with a smart contract. The real-time information, for example, may include the specifics of the transaction request, such as a buy/sell code, a principal amount, a settlement date, a trade date, a net amount, a quantity, a price, a customer account, a deposit account, etc. The real-time information may also include status information associated with each of the tasks required to be performed for settlement of the transaction to be completed. Status indicators may be provided adjacent to each of the required tasks. For example, one indicator may indicate that a task is completed, one indicator may indicate that a task is in progress, and one indicator may indicate that there is an error associated with a task. Any other types of indicators may also be presented.

FIG. 5F illustrates another user interface 550 by which a user may generate a no-code smart contract (in instances in which the smart contract is manually generated). As shown in the figure, rather than a user being required to type code to generate the smart contract, selectable elements may be provide don the user interface. The selectable elements are shown as checkboxes, however, elements of the smart contract may be indicated using any other type of mechanism (e.g., drop down boxes, elements that may be “dragged and dropped” into boxes, etc. The selectable elements are presented in a form that is comprehendible by a user who has knowledge of the types of conditions for settlement of a transaction request, but may not have the knowledge to translate those conditions and actions into a coding language.

The user interfaces depicts in FIGS. 5A-5F are merely illustrative of some exemplary user interfaces associated with the collaborative platform for automated validation and deployment of machine learning models as described herein, and are not intended to illustrate all of the user interfaces that may be presented to the user via the collaborative platform. Other user interfaces may also be presented to allow a user to perform any other operations, view any information, etc. Additionally, the user interfaces illustrated in the figures herein may also be presented in any other manner, including any other arrangement of illustrated elements, including elements not shown in the figures.

### Illustrative System Device Architecture

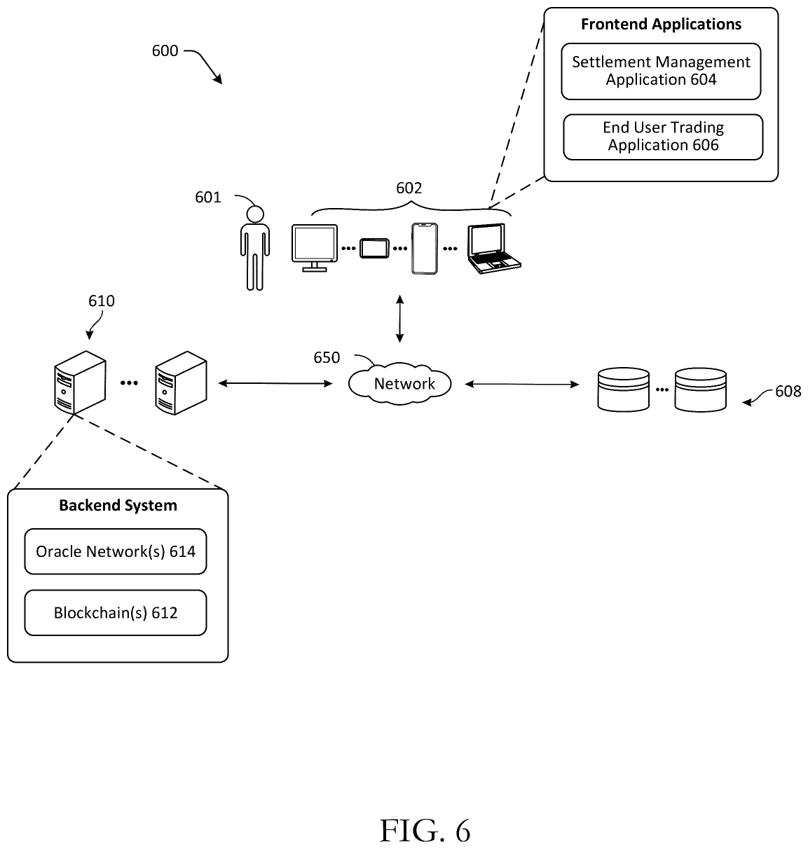

FIG. 6 shows an example system 600 for automated generation and execution of smart contracts for multiple oracle networks. In one or more embodiments, the system may include, one or more user devices 602 (which may be associated with one or more users 601), one or more computing systems 610, and/or one or more databases 620. However, these components of the system 600 are merely exemplary and are not intended to be limiting in any way. For simplicity, reference may be made hereinafter to, user device 602, computing system 610, database 620, etc., however, this is not intended to be limiting and may still refer to any number of such elements.

The user device 602 may be any type of device, such as an e-reader, personal assistant device, speaker, gaming console, smartphone, desktop computer, laptop computer, tablet, smart television (for example, a television with Internet connectivity, the capability to install applications, etc.), and/or any other type of device. Depending on the particular user, the user device 602 may include an application that may allow the user 601 to perform tasks associated with certain aspects of the settlement process.

For example, the user 601 may be a consumer who is making a transaction request via a brokerage account using the device 602. To facilitate this request, the user device 602 may include an end-user trading application 604. The end user trading application 604 may allow the user 601 to perform tasks such as viewing their brokerage account, viewing market information, placing buy or sell trades, transferring funds, and/or any other types of tasks. The user 601 in this example may be the same as the user 102 in FIG. 1, the user device 602 may be the same as the device 104, and the end user trading application 604 may be the same as the frontend application 106.

As another example, the user 601 may be an operator responsible for managing the settlement process of the transaction request submitted by the consumer via the end user trading application 804. To facilitate this process, the user 601 may access a settlement management application 606 via the user device 602. The settlement management application 606 may allow the user 110 to perform tasks such as generating no-code smart contracts, viewing the status of tasks associated with settlement of the transaction request in real-time, viewing information about blocks stored on any blockchains, etc. The user 601 in this example may be the same as the user 110 in FIG. 1, the user device 602 may be the same as the device 112, and the settlement management application 606 may be the same as the frontend application 114. That is, the settlement management application 606 may present any of the user interfaces shown in FIGS. 5A-5F, for example.

The computing system 610 may be a remote system (such as a server, for example) that may include any of the backend for the automated generation and execution of smart contracts for multiple oracle networks as described herein. For example, the computing system 610 may include any of the elements of the system architecture 200. The computing system 610 may include any blockchain(s) 612 (which may be the same as blockchain 120, blockchain 122, blockchain 124, etc.) and oracle network(s) 614 (including inbound, outbound, and any other type of oracle network, such as inbound oracle network 126, inbound oracle network 128, inbound oracle network 130, outbound oracle network 132, outbound oracle network 134, outbound oracle network 136, etc.) used to facilitate data transfer to any from the blockchain(s) 612. The blockchain(s) 612 may include any of the smart contracts that are generated in association with any transaction requests produced by the end user trading application 604.

The database 620 may be an external database that includes information that may be used by the smart contracts stored on the blockchain(s) 612. For example, the database 620 may include pricing and other information about specific stocks, information about funds in a brokerage account of a user, information relating to conditions that trigger actions for a given smart contract, and/or any other information that may be relevant to the settlement process or otherwise.

In one or more embodiments, any of the elements of the system 600 (for example, one or more user devices 602, one or more computing devices 610, one or more databases 620, and/or any other element described with respect to FIG. 6 or otherwise) may be configured to communicate via a communications network 650. The communications network 650 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the communications network 650 may have any suitable communication range associated therewith and may include, for example, global networks (e.g., the Internet), metropolitan area networks (MANs), wide area networks (WANs), local area networks (LANs), or personal area networks (PANs). In addition, communications network 650 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Finally, any of the elements (for example, one or more user devices 602, one or more computing devices 610, one or more databases 620, and/or any other element described with respect to FIG. 6 or otherwise) of the system 600 may include any of the elements of the computing device 700 as well (such as the processor 702, memory 704, etc.).

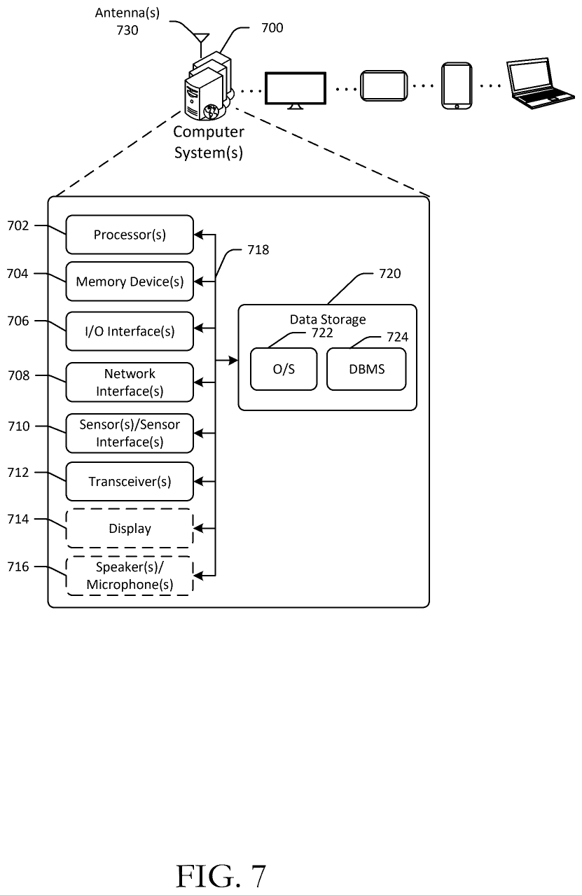

FIG. 7 is a schematic block diagram of one or more illustrative computer system(s) 700 in accordance with one or more example embodiments of the disclosure. The computer system(s) 700 may include any suitable computing device including, but not limited to, a server system, a voice interaction device, a mobile device such as a smartphone, a tablet, an e-reader, a wearable device, or the like; a desktop computer; a laptop computer; a content streaming device; or the like. The computer system(s) 700 may correspond to an illustrative device configuration for a computer system used in conjunction with any one of the system(s) of FIGS. 1-6.

The computer system(s) 700 may be configured to communicate with one or more servers, user devices, or the like. The computer system(s) 700 may be configured to cause the controller and/or computer system(s) to execute, and so forth.

The computer system(s) 700 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computer system(s) 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display(s) 714, one or more optional microphone(s) 716, and data storage 720. The computer system(s) 700 may further include one or more bus(es) 718 that functionally couple various components of the computer system(s) 700. The computer system(s) 700 may further include one or more antenna(s) 730 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the computer system(s) 700. The bus(es) 718 may include, without limitation, a memory bus or a memory controller, a peripheral bus, an accelerated graphics port, and so forth. The bus(es) 718 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 704 of the computer system(s) 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 720 may include removable storage and/or non-removable storage including, but not limited to, magnetic storage, optical disk storage, and/or tape storage. The data storage 720 may provide non-volatile storage of computer-executable instructions and other data. The memory 704 and the data storage 720, removable and/or non-removable, are examples of computer-readable storage media (CRSM) as that term is used herein.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. Moreover, output data generated as a result of execution of the computer-executable instructions by the processor(s) 702 may be stored initially in the memory 704, and may ultimately be copied to the data storage 720 for non-volatile storage.

More specifically, the data storage 720 may store one or more operating systems (O/S) 722; one or more database management systems (DBMS) 724; and one or more program module(s), applications, engines, computer-executable code, scripts, or the like. Some or all of these module(s) may be sub-module(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The data storage 720 may further store various types of data utilized by the components of the computer system(s) 700. Any data stored in the data storage 720 may be loaded into the memory 704 for use by the processor(s) 702 in executing computer-executable code. In addition, any data depicted as being stored in the data storage 720 may potentially be stored in one or more datastore(s) and may be accessed via the DBMS 724 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 702 may be configured to access the memory 704 and execute the computer-executable instructions loaded therein. For example, the processor(s) 702 may be configured to execute the computer-executable instructions of the various program module(s), applications, engines, or the like of the computer system(s) 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to other illustrative components depicted as being stored in the data storage 720, the O/S 722 may be loaded from the data storage 720 into the memory 704 and may provide an interface between other application software executing on the computer system(s) 700 and the hardware resources of the computer system(s) 700. More specifically, the O/S 722 may include a set of computer-executable instructions for managing the hardware resources of the computer system(s) 700 and for providing common services to other application programs (e.g., managing memory allocation among various application programs). In certain example embodiments, the O/S 722 may control execution of the other program module(s). The O/S 722 may include any operating system now known or which may be developed in the future including, but not limited to, any server operating system, any mainframe operating system, or any other proprietary or non-proprietary operating system.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages. The DBMS 724 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computer system(s) 700 is a mobile device, the DBMS 724 may be any suitable lightweight DBMS optimized for performance on a mobile device.

Referring now to other illustrative components of the computer system(s) 700, the input/output (I/O) interface(s) 706 may facilitate the receipt of input information by the computer system(s) 700 from one or more I/O devices as well as the output of information from the computer system(s) 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computer system(s) 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(s) 730 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The computer system(s) 700 may further include one or more network interface(s) 708 via which the computer system(s) 700 may communicate with any of a variety of other systems, platforms, networks, devices, and so forth. The network interface(s) 708 may enable communication, for example, with one or more wireless routers, one or more host servers, one or more web servers, and the like via one or more networks.

The antenna(s) 730 may include any suitable type of antenna depending, for example, on the communications protocols used to transmit or receive signals via the antenna(s) 730. Non-limiting examples of suitable antennas may include directional antennas, non-directional antennas, dipole antennas, folded dipole antennas, patch antennas, multiple-input multiple-output (MIMO) antennas, or the like. The antenna(s) 730 may be communicatively coupled to one or more transceivers 712 or radio components to which or from which signals may be transmitted or received.

As previously described, the antenna(s) 730 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 730 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 730 may be configured to transmit or receive radio frequency signals within any suitable frequency range forming part of the unlicensed portion of the radio spectrum.

The antenna(s) 730 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(s) 730—transmitting or receiving radio frequency (RF) signals in the bandwidth and/or channels corresponding to the communications protocols utilized by the computer system(s) 700 to communicate with other devices. The transceiver(s) 712 may include hardware, software, and/or firmware for modulating, transmitting, or receiving—potentially in cooperation with any of antenna(s) 730—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the computer system(s) 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The optional display(s) 714 may be configured to output light and/or render content. The optional speaker(s)/microphone(s) 716 may be any device configured to receive analog sound input or voice data.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computer system(s) 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the computer system(s) 700 may include alternate and/or additional hardware, software, or firmware components beyond those described or depicted without departing from the scope of the disclosure. More particularly, it should be appreciated that software, firmware, or hardware components depicted as forming part of the computer system(s) 700 are merely illustrative and that some components may not be present or additional components may be provided in various embodiments. While various illustrative program module(s) have been depicted and described as software module(s) stored in the data storage 720, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for case of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

That which is claimed is:

1. A system comprising:
memory that stores computer-executable instructions; and
at least one processor configured to access the memory and execute the computer-executable instructions to:
determine, at a first time interval, a first request to process a first brokerage transaction, wherein the first request comprises first metadata indicating an approved transaction;
determine, using the first metadata, a first smart contract template from a set of smart contract templates;
generate a first smart contract for the first request using the first smart contract template;
send the first smart contract to a first blockchain using a first oracle network;
send the first smart contract to a second blockchain using a second oracle network;
determine, using a third oracle network, that the first smart contract is executed via the first blockchain;
determine, using data published on the first blockchain, that the first request is complete; and
generate, at a second time interval, a settlement notification indicating the first brokerage transaction is settled.

2. The system of claim 1, wherein the first oracle network is an inbound oracle network and the third oracle network is an outbound oracle network, and wherein the first, second, and third oracle networks are decentralized oracle networks.

3. The system of claim 1, wherein the first smart contract is a no-code smart contract.

4. The system of claim 1, wherein an elapsed time between the first time interval and the second time interval is equal to or less than 6.5 hours.

5. The system of claim 1, wherein the at least one processor is further configured to access the memory and execute the computer-executable instructions to:
determine, using a first datastore that is decoupled from the first oracle network, the second oracle network, and the third oracle network, an account identifier;
determine that the first brokerage transaction can be executed using the account identifier; and
send a settlement approval notification to the first oracle network.

6. The system of claim 5, wherein the at least one processor is further configured to access the memory and execute the computer-executable instructions to:
determine, via the first oracle network, that the first smart contract is not executed; and
generate an alert notification indicating the first smart contract is not executed.

7. The system of claim 6, wherein the at least one processor is further configured to access the memory and execute the computer-executable instructions to:
determine that the first smart contract is not executed due to a manual operator action;
generate a message indicating manual operator action is required;
determine that the manual operator action is complete; and
determine that the first smart contract is executed.

8. The system of claim 5, wherein the at least one processor is further configured to access the memory and execute the computer-executable instructions to:
determine, via the first oracle network, that the first smart contract is executed;
determine that the first brokerage transaction is settled; and
generate a status update associated with the first brokerage transaction.

9. The system of claim 1, wherein data associated with the first smart contract comprises time data, execution status data, account identifier data, and transaction amount data, and is devoid of institutional data.

10. The system of claim 1, wherein nodes associated with the first blockchain are disposed on-premises.

11. A method comprising:
determining, by one or more computer processors coupled to memory, at a first time interval, a first request to process a first brokerage transaction, wherein the first request comprises first metadata indicating an approved transaction;
determining, using the first metadata, a first smart contract template from a set of smart contract templates;
generating a first smart contract for the first request using the first smart contract template;
sending the first smart contract to a first blockchain using a first oracle network;
sending the first smart contract to a second blockchain using a second oracle network;
determining, using a third oracle network, that the first smart contract is executed via the first blockchain;
determining, using data published on the first blockchain, that the first request is complete; and
generating, at a second time interval, a settlement notification indicating the first brokerage transaction is settled.

12. The method of claim 11, wherein the first oracle network is an inbound oracle network and the third oracle network is an outbound oracle network, and wherein the first, second, and third oracle networks are decentralized oracle networks.

13. The method of claim 11, wherein the first smart contract is a no-code smart contract.

14. The method of claim 11, wherein an elapsed time between the first time interval and the second time interval is equal to or less than 6.5 hours.

15. The method of claim 11, further comprising:
determining, using a first datastore that is decoupled from the first oracle network, the second oracle network, and the third oracle network, an account identifier;
determining that the first brokerage transaction can be executed using the account identifier; and
sending a settlement approval notification to the first oracle network.

16. The method of claim 15, further comprising:
determining, via the first oracle network, that the first smart contract is not executed; and
generating an alert notification indicating the first smart contract is not executed.

17. The method of claim 16, further comprising:
determining that the first smart contract is not executed due to a manual operator action;
generating a message indicating manual operator action is required;
determining that the manual operator action is complete; and
determining that the first smart contract is executed.

18. The method of claim 15, further comprising:
determining, via the first oracle network, that the first smart contract is executed;
determining that the first brokerage transaction is settled; and
generating a status update associated with the first brokerage transaction.

19. The method of claim 11, wherein data associated with the first smart contract comprises time data, execution status data, account identifier data, and transaction amount data, and is devoid of institutional data.

20. A method comprising:
determining, by one or more computer processors coupled to memory, at a first time interval, a first request to process a first brokerage transaction, wherein the first request comprises first metadata indicating an approved transaction;
determining, using the first metadata, a first smart contract template from a set of smart contract templates;
generating a first smart contract for the first request using the first smart contract template;
sending the first smart contract to a first blockchain using a first oracle network;
sending the first smart contract to a second blockchain using a second oracle network;
determining, using a third oracle network, that the first smart contract is executed via the first blockchain;
determining, using data published on the first blockchain, that the first request is complete;
generating, at a second time interval, a settlement notification indicating the first brokerage transaction is settled;
determining, using a first datastore that is decoupled from the first oracle network, the second oracle network, and the third oracle network, an account identifier;
determining that the first brokerage transaction can be executed using the account identifier;
sending a settlement approval notification to the first oracle network;
determining, via the first oracle network, that the first smart contract is not executed;
generating an alert notification indicating the first smart contract is not executed;
determining that the first smart contract is not executed due to a manual operator action;
generating a message indicating manual operator action is required;
determining that the manual operator action is complete; and
determining that the first smart contract is executed.
